(19) United States
(12) Patent Application Publication
(10) Pub. No.: US 2016/0015001 A1
(43) Pub. Date: Jan. 21, 2016

(54) DOG CHEW MADE BY ANIMAL SKINS RECOMBINANT MOLDING TECHNIQUE

(71) Applicant: Wenzhou Yuanfei Pet Toy Products Co., Ltd, Zhejiang (CN)

(72) Inventors: Zhuang Ming Yun, Chejiang (CN); Zhu Xiao Rong, Chejiang (CN)

(73) Assignee: WENZHOU YUANFEI PET TOY PRODUCTS CO., LTD, Zhejiang (CN)

(21) Appl. No.: 14/799,051

(22) Filed: Jul. 14, 2015

(30) Foreign Application Priority Data
Jul. 15, 2014 (CN) 201410336605.8

(51) Int. Cl. A01K 11/00; A23K 1/18; A23K 1/16; A23K 1/00

(52) U.S. Cl. CPC A01K 15/026; A23K 1/003; A23K 1/1846; A23K 1/1631

(57) ABSTRACT

A recombinant dog chews from animal skin forming technique is disclosed. The process comprising the steps of: granulate the scrap skin materials. After cortical granulate, the piece size is 0.5 mm-20 mm; put the skin particulates into clean water and soak, the soaking time is not less than 2 h; 3) After soaking, the cortical granules were melted at a pre-set temperature. Forming a gel and extruded to form a whole piece skin. Through this process the recombinant animal skins become homogeneous structure, there is no grainy after this process, the product quality was enhanced. Since we do not add any kind of binder such as gelatin, a recombinant hide has a very excellent flexibility, the toughness was almost the same, thus it's easier to tie a knot during the manufacturing process later on.

### CROSS REFERENCE TO RELATED APPLICATION

This Utility Patent Application claims priority to Chinese Patent Application No. 201410336605.8, filed Jul. 15, 2014; and which is incorporated herein by reference.

### BACKGROUND

The invention relates to recombinant animal skin molding technology, it involves a particularly recombinant and reformulation manufacturing process.

With the development of technology, animal skins have also been widely used for dog chew production.

Dog chews are well known as a pet toy or pet food. They help to clean the pet's teeth. Usually it is made as a bone, a ball, circles, sticks, shoes and other shapes etc. In general, the raw materials we used for dog chew production should be complete, whole piece without tears. The hide should be in right sizes. To procure a whole piece hide without any defect in the market, the price is very high though the material consumption is comparatively higher. While for the crippled animal skins, the price is lower but the utilization rate is low, higher scrap rate as well.

Therefore, how to effectively use the scrap is a common concern of the manufacturers nowadays. A great number of factories granulate the scraps to obtain cortical particles, and then mix and blend together with other particles and edible gelatin adhesive, extruded and injected to form different shapes. For instance, bones, crabs, fishes and other shapes. The sheets obtained from this process can also be made as different shapes like knotted bones.

Although manufacturers use their method to achieve and make use of the scraps, there are disadvantages as listed below:

First, a large cortical granules crushed, did not go through the state of solving the fibers of collagen, thus the particles cannot adhere to each other of which require to use binder such as gelatin to bond them altogether. The product apparently in a lower grade if it is obtained in a non-homogeneous structure.

Second, the gelatin becomes brittle when it is dry. It is difficult to deal with the subsequent tie manufacturing process.

So, how can we make the reorganization of animal skin showing homogeneous structure, and to make it soft and easy for subsequent knotted handling. This is a technical issue our technician need to solve currently.

For these and other reasons, there is a need for the present invention.

### BRIEF DESCRIPTION OF THE DRAWINGS

The accompanying drawings are included to provide a further understanding of embodiments and are incorporated in and constitute a part of this specification. The drawings illustrate embodiments and together with the description serve to explain principles of embodiments. Other embodiments and many of the intended advantages of embodiments will be readily appreciated as they become better understood by reference to the following detailed description. The elements of the drawings are not necessarily to scale relative to each other. Like reference numerals designate corresponding similar parts.

FIG. 1 is a flowchart of illustrating one embodiment of a method an animal skins recombinant dog chews molding process.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

It is to be understood that the features of the various exemplary embodiments described herein may be combined with each other, unless specifically noted otherwise.

The purpose of the invention is to provide a recombinant dog chews made by animal skin molding process, so that the skin is soft and showed homogeneous structure, therefore the subsequent production of a more suitable dog chews or pet's toys.

To solve the above mentioned existing technology problems, this invention provides recombinant dog chews from animal skin molding process consists of the following steps:
1) the cortical scrap was crushed and the pulverized cortical granule size is 0.5 mm-20 mm;
2) put the cortical granules into clean water and the soaking time is not less than 2 h;
3) put the soaked cortical granules at a preset temperature melts them to form gel, and extrude the shape at a predetermined pressure into a whole animal skin.

In one example, in the above-mentioned restructuring dog chews from animal skin molding process, the said step 2) of the soaking time is 2 h-24 h. In one example, in the above-mentioned restructuring dog chews from animal skin molding process, the step 2), the temperature of water is 10° C.-65° C.

In one example, in the above-mentioned restructuring dog chews from animal skin molding process, the step 3) is completed in an extruder

In one example, in the above-mentioned restructuring dog chews from animal skin molding process, the predetermined temperature is 30° C.-60° C.

In one example, in the above-mentioned restructuring dog chews from animal skin molding process, between the step 2) and the step 3) comprising the step of:

2.1) adding a protein mixture in the cortical granules that soaked.

In one example, in the above-mentioned restructuring dog chews from animal skin molding process, the protein mixture is a vegetable protein, a mixture of animal protein or both, wherein the vegetable protein is soy protein concentrate, isolated soy protein, wheat gluten egg white, hordeins, oat protein kafirin, one or more of a mixture and; the said animal protein glue original protein, casein, gelatin and keratin one or more thereof.

In one example, in the above-mentioned restructuring dog chews from animal skin molding process, the step 3) comprising administering to the skin particulates with a flavor enhancer.

In one example, the step further comprises adding nutrients to the CGs 3), the nutritional substance is vegetables, fruits, poultry, vitamins, chlorophyll, minerals and grain in one or more of the combinations.

In one example, the scraps are the beehide scraps after trimmed.

As can be seen from the above technical solution, this invention was disclosed the reformulation of animal skins molding process, first the leather scrap is crushed and the pulverized particle size will between 0.5 mm-20 mm, then put the cortical granules into the water not less than two hours, and finally put the cortical granules at a predetermined temperature melts to form gel, and huddled under a predetermined pressure to form the whole animal skin.

Since the hide trim has become a smash particle size in the range of 0.5 mm-20 mm small size cortical granules, the small size of cortical granules is an easy process to fully soaked absorbent saturated, which is conducive to the small size of cortical granule in the heated state rapidly melting become collagen and elastin, which has been heated up to saturation of cortical granules at the predetermined temperature, all the small size of cortical granules dissolving into collagen and elastin, the inherent viscosity of collagen makes all the small size of cortical granules fuse to become a colloidal state, and then extruded the gel-like substance out of cooling at a preset pressure to form the entire animal skin.

Thus, the present invention provides recombinant dog chews from an animal skin molding process, and did not add any adhesive like gelatin. Instead by making small size of cortical granules melting become collagen and elastin, collagen through white self-adhesive makes small particles reorganized into animal skin, due to the small size of the cortical particles have been melted for collage and elastin, thus after the reorganization of animal skins for the homogeneous structure, there is no grainy, enhance product quality, and because of no gelatin and other binders such animals reconstituted leather has excellent flexibility and toughness almost the same as undifferentiated original animals skins, of which makes the subsequent process more convenient and easy to tie.

The core of the invention is to provide a recombinant dog chews from animal skin molding process, so that the production of animal skins is soft and showed homogeneous structure, so that the subsequent production of a more suitable for dog chews or other pets to play.

In order to enable the skilled person to better understand the present invention, the accompanying drawings and the following specific embodiments of the present invention is further described in detail.

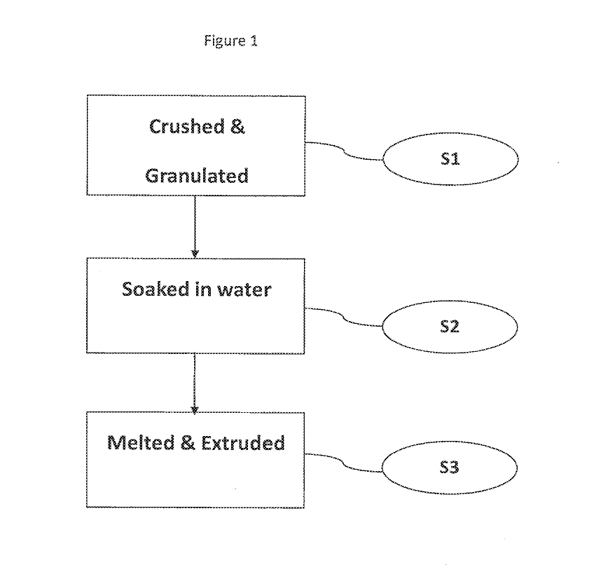

In reference to FIG. 1, the FIG. 1 embodiment of the present invention is provided with animal skins recombinant dog chews square molding process implementation.

In the flowchart, the embodiment dog chews from animal skins restructuring process embodiment is disclosed, comprising the steps of:

S1) Crushed, in detail, is to use the remaining scrap animal skins to crush and pulverize cortex stars. Grain size should be controlled within a range of 0.5 mm-20 mm, and preferably 0.5 mm, 2 mm and 3 mm small size of cortical granules. Need to be noted that, when the animal skin scrap pulverized in a wet state can also be dried form, as long as it can be let the grinding mill to process required granularity, there is no restriction of this invention to be crushed when animal skins is dry and wet scrap, of course the moisture content is about 50% of the animal skin scrap is the best, the kind of scraps is not very soft, but easy to be pulverized, without causing damage to the grinder.

S2) Soaking, specifically to put the crushed cortical granules into the water to soak. The soak time shall not be less than two hours in order to make full cortical granule swelling, conducive to the rapid decomposition subsequent heating.

Less impact by the clean water temperature stage, but usually, with the increase of the water temperature, the time needed to soak is shortened, such as the water temperature at 50° C., need soaking time of 2.5 hours, and the water temperature at 40° C., need the soak time of 3 hours, the water temperature at 10° C., cortical granules soaked in water for 24 hours need to be fully absorbing expansion, therefore, the present invention it is preferable to control the water temperature in the range of 10° C.-65° C., the corresponding soaking time was in 2 hours within the time to 24 hours, which is mainly on account one can guarantee adequate cortical granules absorb water, on the other hand they can be shortened the soaking time and improve production efficiency.

S3) melt and extrusion, specifically, the water absorption after soaking cortical granules heated to a predetermined temperature and a predetermined pressure. Then it was extruded to form the entire animal skin. Typically, this step is within a predetermined temperature range of 30° C.-60° C. in order to both to ensure full melting of cortical granules collagen and elastin, the formation of gum and can effectively prevent collagen protein and elastin coking

For more convenience, step S3) is usually happens in an extruder, once the cortical granules was done that both the heating and jelly shapes these 2 processes was within the extruder, the products are exactly the same shape as the end of extruder. For example, with an oval head set, then the whole of the animal skin is extruded from the extruder as oval animal skins, and if the head of the extruder's knife is rectangle, then produce a whole animal skin animal skin was rectangular.

In the above embodiment scrap crushed animal skins became pellets in the size range of 0.5 mm-20 mm. The degree of cortical granules, small particle size CGs are easily to fully soaked absorbent saturated, which is conducive to small size of cortical granules in a heated state rapidly melting become collagen and elastin, will have reached saturation cortical particles are heated to a predetermined temperature, all the small size of cortical granules dissolving into collagen and elastin, collagen white inherent viscosity so that all the small size of cortical granules fuse to become a colloidal state, and then the gel-like substance in a predetermined extrusion cooling under pressure to form the entire animal skin.

Thus, the invention provides recombinant dog chews from animal skin molding process, did not add the gelatin or other adhesives, but by making small size of cortical granules melting become collagen and elastin, collagen through white self-adhesive makes small particles reorganized into animal skin, due to the small size of the cortical particles have been melted for collagen and elastin, thus after the reorganization of animal skins for the homogeneous structure, there is no grainy, enhance product quality, and because no gelatin and other binders such animals reconstituted leather has excellent flexibility and toughness almost undifferentiated the original animal skin, which makes the subsequent process becomes convenient and easy to tie.

To further optimize the above-described embodiments of the program, the higher the protein content of pet food or toys, in this preferred embodiment between steps S2) and step S3, add the step S21—add the protein mixture after immersion in the cortical granules.

Note that needed to be further explained, for example, the protein mixture of the present embodiment is a plant protein, animal protein, or both mixtures thereof, and vegetable protein is soy protein concentrate, isolated soy protein, wheat gluten, hordein, Yan wheat protein and kafirin one or more thereof; and one or more substance collagen protein, casein, gelatin and of a mixture of keratin proteins.

Protein mixture is added, not only to further improve the nutritional content of dog chews, but also let the animal skin restructuring easier, protein inherent viscosity makes cortical granules melted more easily together. Of course, in addition, it can also add nutrients to the cortical granules, specifically in step S3) further including the cortical granules added nutrients, nutrients usually vegetables, fruits, poultry meat, vitamins, chlorophyll, minerals or a combination of substance and a cereals.

From the viewpoint of taste, the process of the present embodiment the recombinant animal skin as provided in step S3) further comprises the CGs added flavor enhancer, colloidal material and mixing flavoring substances in the extruder, so that the dog chew made by the reorganization of animal skins taste better.

Flavor enhancer may generally be expected stew, soup bones, edible spices and other seasonings, in order to effectively enhance the taste of the dog chews. The following provides a specific procedure of a beef hide dog chews reorganization, the operation of other animal skins can refer to the production process of the beef hide.

### FIRST EXAMPLE

Crushed and granulate the pig beef scrap to become 2 mm particle size and then soak in warm water 60° C. for 2 hours, then remove the skin particles from the water and placed in an extruder, extrusion temperature of the extruder adjusted to 35° C., from the end of the extruder to obtain whole recombinant leather.

Cut the pig beef hides into strips, then tie them into knotted bone shapes dog chews. The surface is smooth, delicate and the toughness is very good, there is no hard and brittle phenomenon, both to meet the requirements of the pet playing or eating, and will not cause harm to the mouth of dogs and other pets.

### SECOND EXAMPLE

The rawhide trim pulverized become particle size of 3 mm, and soak in warm water 45° C. for 2.5 hours and then remove the hide particles from water and placed in an extruder, adjust the temperature of the extruder to 45° C., a whole sheet of reformulated hide was obtained from the end of the extruder.

Cut the sheet of the hide into strips and tie them into knotted bones, the surface is smooth, delicate and good toughness. There is no hard and brittle phenomenon, both to meet the requirements of the pet playing or eating and will not cause harm to the mouth of dogs or other pets.

### THIRD EXAMPLE

The rawhide trim pulverized become particle size of 0.5 mm, and soak in warm water 30° C. for 12 hours and then after the hide particles were removed from water and placed in an extruder, extrusion temperature of the extruder adjusted to 50° C., from the end of the extruder to obtain the whole restructuring rawhide.

Cut the hides into strips and tie them into knotted bones, the surface of the is smooth, delicate and good toughness, there is no hard and brittle phenomenon, both to meet the requirements of the pet playing or eating, and will not cause any harm to the mouth of dogs and other pets.

This is clearly note that using dog chews made from animal skins recombinant process of the invention disclosed, it is completely meet with production needs of the dog chews, but also overcome the existed structure heterogeneity, exist particle and more brittle shortcomings of current recombinant animal skin.

In this paper, a case of the application of the principles and specific embodiments of this invention have been set forth, the above embodiment is a method used to help understand this invention and its core idea. It should be noted that the skillful technician is allowed to make the improvement and modification on the technology without departing from the principles of the invention. And all the improvement and modification are also fall within the scope of the invention as claimed.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A method of forming a dog chew by an animal skins recombinant molding technique, comprising:
1) cortical scrap was crushed and the size of pulverized cortical granule is 0.5 mm-20 mm;
2) submerge the cortical granules into clean water, the soaking time is not less than 2 h;
3) the soaked cortical granules was melted at a predetermined temperature to form gel; and extruded to form a whole piece of animal skin.

2. The method of claim 1, wherein the recombinant animal skin molding process, characterized in that said step 2)The soaking time of 2 h-24 h.

3. The method of claim 1, wherein the recombinant animal skin molding process, characterized in that said step 2) The water temperature is 10° C.-65° C.

4. The method of claim 1, wherein the recombinant animal skin molding process, characterized in that said step 3) Done in the extruder.

5. The method of claim 4, wherein the recombinant animal skin molding process, characterized in that said preset temperature is 30° C.-60° C.

6. The method of claim 1, wherein the recombinant molding process, characterized in that said step 2) and step 3) including the following steps:
21) added the protein mixture to the cortical granules after they are soaked.

7. The method of claim 6, wherein the recombinant animal skin molding process, the characteristic is wherein the said protein mixture compound is a mixture of plant protein, animal protein, or both, wherein the said vegetable protein is one of the condense soy protein, soy isolate protein, wheat gluten, hordein, oat protein and kafirin or more thereof; The animal protein is one of the collagen, casein, gelatin and keratin mixture or more of them.

8. The method of claim 1, wherein the recombinant animal skin molding process, characterized in that said step 3) adding to flavor enhancer to the said cortical granules.

9. The method of claim 1, wherein the recombinant animal skin molding process, characterized in that said step 3) adding nutrients to the cortical granules, the nutrients of vegetables, fruits, poultry meat, vitamins, Chlorophyll, minerals, either one or a combination of cereals.

10. The method according to any one of claims from 1-9 of dog chews from animal skins recombinant molding technique, characterized in that said is cowhide trim scrap.
